(19) United States
(12) Patent Application Publication
(10) Pub. No.: US 2018/0347843 A1
(43) Pub. Date: Dec. 6, 2018

(54) METHODS AND SYSTEMS FOR PROGNOSTIC ANALYSIS IN ELECTROMECHANICAL AND ENVIRONMENTAL CONTROL EQUIPMENT IN BUILDING MANAGEMENT SYSTEMS

(71) Applicant: Mikros Systems Corporation, Fort Washington, PA (US)

(72) Inventors: Corey W. Friedenberger, Bristol, PA (US); Kavitha Siddaraju, Flanders, NJ (US); Richard A. Frantz, Hatboro, PA (US); Timothy Mcgrath, Philadelphia, PA (US); Sean P. Moore, Philadelphia, PA (US)

(73) Assignee: Mikros Systems Corporation, Fort Washington, PA (US)

(21) Appl. No.: 15/988,775

(22) Filed: May 24, 2018

Related U.S. Application Data
(60) Provisional application No. 62/512,392, filed on May 30, 2017.

(51) Int. Cl. F24F 11/38; G05B 23/02; G06Q 10/00; F24F 11/36

(52) U.S. Cl. CPC F24F 11/38; F24F 11/36; G06Q 10/20; G05B 23/0283

(57) ABSTRACT

Methods and systems for prognostic analysis in electromechanical and environmental control equipment in building management systems are described. In performing the prognostic analysis, the prognostics system acquires leading indicator input data representing the monitored signals associated with the target equipment and determine a prognostics model corresponding to the target equipment. The prognostics system applies the prognostics model to the leading indicator input data to determine a condition of the target equipment. The condition includes a current condition and/or a future condition of the target equipment. The prognostics system also outputs the condition of the target equipment to a database for accessing by a remote device or operator.

### CROSS-REFERENCE TO RELATED APPLICATIONS

This patent document claims priority under 35 U.S.C. § 119(e) to the U.S. Provisional Patent Application No. 62/512,392, filed May 30, 2017. This Provisional U.S. Application is incorporated herein by reference in its entirety.

### BACKGROUND

This disclosure relates to system and method for prognostic analysis to predict failures for electromechanical and environmental control equipment commonly used in modern building management systems. Proper maintenance of HVAC and other building infrastructure can save 5-15% of energy costs, according to the U.S. Department of Energy (see https://energy.gov/energysaver/maintaining-your-air-conditioner).

Current maintenance strategies are generally based on a “maintenance only when needed” approach and Condition-Based Maintenance (CBM). However, existing systems used for real-time monitoring HVAC equipment only provide diagnostic information and fault detection when a malfunction occurs.

It is thus an aim of this disclosure to provide systems and methods for prognostic analysis in electromechanical and environmental control equipment in building management systems. The systems and methods, in addition to providing real-time monitoring and diagnostics, predict failures using predictive analytics or prognostics algorithms.

### SUMMARY

This disclosure provides a prognostics system for monitoring a target equipment (e.g., electromechanical and electronic equipment or system) in a building management system. The prognostics system includes one or more sensors each configured to monitor a signal associated with the target equipment, a processing device, a data store containing prognostics models associated with one or more pieces of equipment in the building management system, and non-transitory computer-readable medium containing programming instructions. The programming instructions are configured to cause the processing device to: (1) acquire leading indicator input data representing the monitored signals associated with the target equipment, (2) determine a prognostics model corresponding to the target equipment, (3) apply the prognostics model to the leading indicator input data to determine a condition of the target equipment; the condition includes a current condition and/or a future condition of the target equipment, and (4) output the condition of the target equipment to a database for accessing by a remote device or operator.

In some scenarios, the prognostics system may generate, based on the current condition, an alert associated with an individual component or subsystem of the target equipment. The alert may include a failure alert of the target equipment indicating an existing fault that requires corrective action and/or a prognostic alert predicting a future occurrence of a fault within a predetermined timeframe. In some scenarios, the prognostic alert may include a confidence level indicating a probability of occurrence of the fault within the predetermined timeframe based on the quality of the leading indicator input data. In some scenarios, the prognostics system may provide a recommendation of corrective action based on the generated alert associated with the individual component or subsystem of the target equipment.

In some scenarios, the prognostics model may include: a hierarchical description associated with a piece of equipment in the building management system; leading indicator input data associated with the piece of equipment in the building management system; mathematical functions which are applied to the leading input data; and a fault symptom mapping matrix relating the leading indicator input data to possible faults in the piece of equipment. The system may further apply the fault symptom matrix to the leading indicator input data representing the monitored signals associated with the target equipment and the outputs of the mathematical calculations applied to these data to determine possible faults in the target equipment. In some scenarios, the prognostics model includes internally-generated data further including times, locations, or system descriptions.

In some scenarios, in determining the condition of the target equipment, the prognostics system may compare actual observed operational results based on the acquired leading indicator data and simulated operational results. In some scenarios, in determining the condition of the target equipment, the prognostics system may detect a deviation of the actual observed operational results based on the acquired leading indicator data from a nominal statistical pattern.

In some scenarios, the target system is an HVAC equipment, and the leading indicator input data include one or more of the following: fluid temperatures, hardware temperatures, hardware status proofs, operational settings, and fluid pressures.

In some scenarios, the prognostics model further includes one or more functions configured to: determine a normal operational status (baseline data) of the building management system; refine the baseline data over time; calculate a rooftop unit (RTU) return-to-supply air differential temperature; determine a historical rate of change for one or more system parameters of the building management system; calculate a refrigerant temperature based on a measured pressure; determine that a compressor is running based on measured pressures; or determine a true enable status of an indoor blower fan based on system status when non-measurable, internal logic is used by the target system such as a fan “auto” setting.

In some scenarios, the current condition of the target equipment includes a remaining useful life (RUL) for individual components or subsystems with expected lifespans shorter than that of the overall system.

In some scenarios, in determining the current condition of the target equipment, the prognostics system may determine an estimated RUL based on comparing measured system data with engineering data or determine an estimated RUL based on comparing an accumulated operating time of the filter with a mean time between failure (MTBF) data.

In some scenarios, in determining the current condition of the target equipment, the prognostics system may assign a specific fault to the individual component or subsystem.

In some scenarios, the target equipment includes a filter, for which the RUL is an estimated time remaining before it is required to change the filter.

This disclosure also provides a method for monitoring a target equipment in a building management system. The method includes: (1) acquiring leading indicator input data based on signals from one or more sensors, wherein the signals are associated with a target equipment; (2) determining a prognostics model corresponding to the target equipment; (3) applying the prognostics model to the leading indicator input data to determine a condition of the target equipment; the condition includes a current condition and/or a future condition of the target equipment; and (4) outputting the condition of the target equipment to a database for accessing by a remote device or operator.

### BRIEF DESCRIPTION OF THE DRAWINGS

The objects, features, and advantages of the present disclosure will be apparent from the following description of particular embodiments of those inventive concepts, as illustrated in the accompanying drawings. The drawings depict only typical embodiments of the present disclosure and, therefore, are not to be considered limiting in scope.

FIG. 1 illustrates an example of a top-level system architecture for monitoring and prognostics for HVACR equipment.

FIG. 2 illustrates an example of target system telemetry, hierarchal prognostics model, and prognostic outputs.

FIG. 3 illustrates an example of a process for monitoring a target equipment in a building management system

### DETAILED DESCRIPTION

This disclosure is not limited to the particular systems, methodologies or protocols described, as these may vary. The terminology used in this description is to describe the particular versions or embodiments only and is not intended to limit the scope.

Prognostic analysis is a hardware-software approach to monitoring and predicting the performance of electromechanical and electronic systems and equipment (“target system”). System monitoring is performed using smart sensor and bus monitor hardware and software interfaces to acquire key performance parameters (“leading indicators”) in real-time or near real-time. Each target HVAC equipment unit provides leading indicator maintenance data using integrated sensors to measure key performance indicators (KPIs) such as pressures, temperatures, humidity and power levels. These sensors may be built into the equipment, and typically provide data using an available instrumentation bus protocol, such as BACnet. Ancillary sensors may be added if needed, e.g., for thermography, vibration analysis or leak detection.

The leading indicator data are then sent to the prognostics engine. In some scenarios, the data acquired may be preprocessed by a smart sensor module, and are then sent to the prognostics engine for further processing to assess performance, detect current failures (diagnostics), and predict future failures (prognostics).

The prognostics engine may use one or more methods and computational algorithms, such as expert system-based methods and model-based methods. Additional methods and computational algorithms that can be employed by the prognostics engine include “big data” analytics methods (e.g., neural network and deep learning approaches).

One of the key outputs of the prognostics analysis is the Remaining Useful Life (RUL) of a system, subsystem, or component. RUL is a prediction of the remaining time until a failure or loss of usefulness of a system, subsystem, or component with an expected lifespan, such as a typically consumable item (e.g., a filter). RUL may include a confidence factor to account for variability between specific instances of components and for uncertainties in the data used to calculate RUL.

Examples of electromechanical and environmental control equipment commonly used in modern building management systems may include:
Heating, Ventilation, and Air Conditioning (HVAC) equipment
Chillers, cooling towers, and refrigeration equipment
Electric motors, generators, pumps, lighting, and power distribution
Elevators, escalators, and conveyor belts.

In some scenarios, the prognostics system may apply an expert system-based or model-based approach. An expert system-based approach for the prognostic analysis is characterized by making use of technical information about the target system (in contrast to a typical big data approach, which is “purely data-driven” with consideration for system architecture or context). This technical information is embodied in a prognostics model of the target system, which is used by the prognostic analysis software/algorithms.

There may be variations in the model-based approach. For example, the prognostics model can be a fully-functional simulation of the operation of a target system, which is carried out based on the prognostics model, in parallel with monitoring the actual operation of the target system. In this example, the model-based approach is based on analysis of the variances between simulated and actual observed operational results (also referred as “residuals”). In another example, the prognostics model may involve a (postulated or observed) statistical characterization of the monitored leading indicator signals. In this approach, which includes some Bayesian methods, the prognostic analysis is based on detecting deviations from the nominal statistical pattern.

In a preferred implementation, a prognostics model may embody various design and technical information about the target system in the form of a hierarchical description of the system, including: (i) subsystems, components, leading indicator telemetry to be monitored, (ii) mathematical algorithms to interpret and transform the leading indicators, and (iii) prescribed algorithm outputs that describe diagnostic faults, prognostic faults, and RUL.

### Prognostic Analysis for Building Management Systems

The prognostic analysis for building management equipment can be performed using a prognostics engine. The prognostics engine may utilize an expert system-based or model-based approach, as described above. The prognostics system is able to perform both diagnostics (near real-time fault detection) and prognostics (predictions) using the same model.

In some scenarios, the “model-based” approach can be implemented in a set of software components, to support the creation of prognostics models (as defined by the preferred implementation above) and the application of these prognostics models to monitor, diagnose and predict equipment failures at the system, subsystem, and component levels. In addition, for Health Management Systems (HMS) and Condition Based Maintenance (CBM) applications, the runtime components are often used to support the application of the prognostics models.

These prognostics models provide an innovative and cost-effective approach to describing equipment operation in a manner suitable for identifying equipment status, failure causes and impending failures in real time. The prognostics models may include:
The leading indicator data inputs;
Computations performed;
Hierarchical equipment description; and
Fault symptom matrices, which relate the processed input data and the computational outputs to possible faults in the target equipment.

In some scenarios, the prognostics engine may provide a modular approach to implementing the software for monitoring equipment, diagnosing failures, and predicting impending failures by dividing the software into three independent modules:
The prognostics model including leading indicators, computations, equipment descriptions, and fault symptom matrices;
The Prognostics Framework (PF) runtime software that implements the models; and
The custom software that obtains the data and delivers the monitoring, diagnosis, and prediction information to operators and other users.

Prognostics Framework (PF) refers to a set of software implementing the prognostics models provided in the prognostics engine.

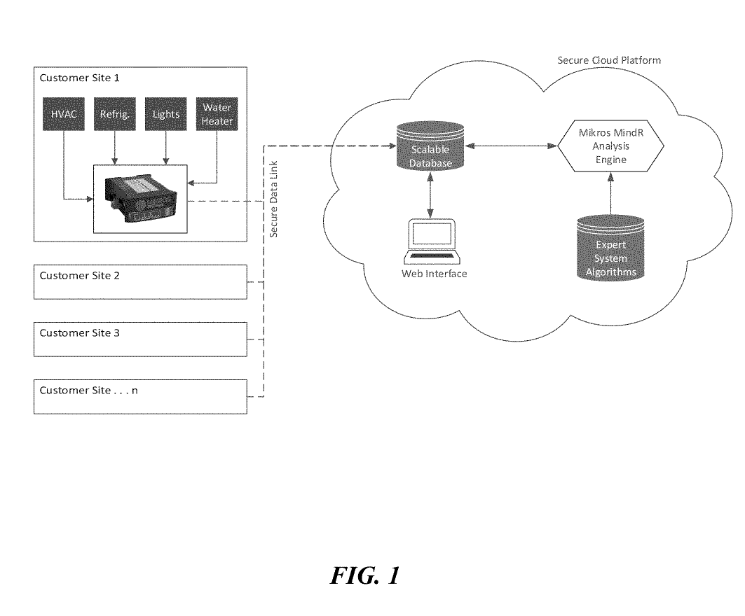

FIG. 1 illustrates an example of a system architecture for monitoring a target equipment in a building management system. In some scenarios, the custom software used for the target equipment in building infrastructures further includes: (1) data capture software that interfaces with equipment or equipment aggregation software to obtain the PF input data; (2) the analysis software that applies the PF model and saves the captured data and PF provided data; and (3) the user interface software that provides network and/or web access to the current information and to the relevant data for addressing equipment failures and impending failures.

### Modeling Approach

The modeling approaches now further explained. The model-based approach used by the prognostics engine is driven by the knowledge of engineering experts of a target system that allows manipulation of leading indicators and mapping of data (e.g., raw inputs and calculated parameters) to known fault modes. The mapping of data to known fault modes is useful in diagnosing and solving existing and pending system failures. This approach requires a detailed working knowledge of the target system so that it can be decomposed into key, hierarchal components—each associated with data and discrete faults.

For example, an HVAC rooftop unit (RTU) may be broken down into the following subsystems and components:
Compressor
Evaporator
Condenser
Blower Unit
   Blower Motor
   Blower Fan
   Blower Belt
Air Return and Ducting
   Filters
   Smoke Detector

Depending on the granularity and quality of available data and on the depth of engineering knowledge specific to the target system, the subsystems may be further decomposed, resolving outputs into increasingly useful specific information or actions. The subsystems and components vary by target system but typically include common top-level items. The modular nature of the hierarchal structure allows common top-level items to be reused between different models without significant reconstruction.

In some scenarios, each subsystem and component is assigned specific faults that are useful to locating or correcting detrimental conditions. For example, coils and filters typically include a fault that they or their filters are dirty, resulting in degraded cooling performance. These faults may be triggered by a one-to-one mapping of prescribed data or may be triggered by complex calculations and mappings utilizing many simultaneous data.

The hierarchy allows for faults to flow upward through the system, which is important when the system is decomposed into a detailed hierarchy where a failure at the component level can lead to degradation or failure at higher levels. For example, poor performance of the blower unit belt causes the entire blower to perform poorly, leads to reduced cooling capacity, and can eventually, if left alone, lead to reduced lifespan elsewhere in the system.

Triggered faults result in outputs that are segregated into two categories: diagnostic alerts and prognostic alerts. Diagnostic alerts are the typical “time equals zero” alerts where a fault condition currently exists, indicating a problem that has already occurred and may require immediate corrective action. In contrast, prognostic alerts provide predictive alerts forecasting future faults that have not yet occurred but are believed to be probable in some defined timeframe. For example, prognostic alerts are available in the CBM application.

In some scenarios, prognostic alerts are determined by observing trends in changing system data that indicate the system is moving towards an out-of-tolerance state and will reach a fault condition in the future. In many cases, confidence levels can be calculated for an alert, indicating the probability of the fault condition and timeframe based on the quality of data. Prognostic alerts allow preventative maintenance or preparation before a diagnostic alert occurs. In some cases, specific actions can be assigned to diagnostic or prognostic alerts, offering recommendations to operators for correcting the fault condition. Both diagnostic and prognostic alerts can be automatically cleared when the fault condition is corrected or manually cleared by an operator, depending on the nature of the fault, the nature of the data, and the requirements of a monitored site.

### Implementations of Prognostics Framework Model

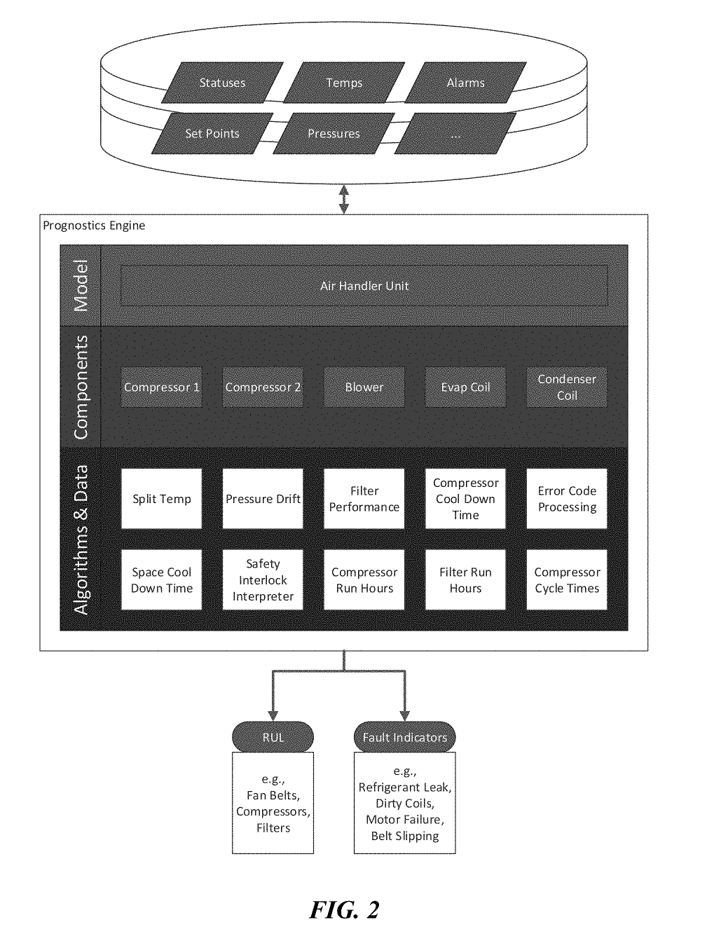

Leading indicator data is highly variable depending on the specific hardware installed at a given site and how it has been configured by the building owners and maintenance activities. FIG. 2 includes an illustration of example leading indicator data and how it can be transformed into diagnostic and prognostic outputs. In a non-limiting example, leading indicator data, for a HVAC rooftop unit, include:
1. Air Temperatures
   a. Return Air
   b. Supply Air
   c. Outdoor Air
2. Hardware Temperatures
   a. Compressor
3. Hardware Status Proofs
   a. Compressors
   b. Condenser Fans
4. Operational Settings
   a. Cooling Enables
   b. Heating Enables
   c. Fan Modes
   d. Heating Set Points
   e. Cooling Set Points
5. Pressures
   a. Coolant Discharge
   b. Coolant Suction
   c. Air Filter Differential
   d. Supply Air Pressure
6. Misc
   a. Smoke Detectors
   b. Other Alarms
   c. Current Time

The implementations of the prognostics algorithms are further explained below. In some scenarios, the prognostics engine uses custom algorithms to dissect and process raw leading indicator data into intermediate data, such as useful parameters for fault determination. These algorithms include one-to-one mapping of the intermediate data and algorithms that transform the intermediate data into meaningful outputs and perform other useful functions, including:
1. Auto Baseline Automatically establishes the normal operational status of the system for later comparison.
2. Split Temperature Calculates the RTU return-to-supply air differential temperature.
3. Drift Rate Determines the historical rate of change for system parameters, which is important when some faults are distinguished by one another only by the rate at which their symptom present.
4. Refrigerant Pressure to Temperature Calculates refrigerant temperature based on measured pressures for cases where a target system does not have explicit temperature sensors on the refrigerant lines.
5. Compressor Proof from Pressure Determines if a compressor is running based on available pressure data when explicit compressor proof sensors are not included on a target system.
6. Auto Fan Enable Determines the true enable status of the indoor blower fan based on system status when the fan setting is set to “auto” instead of an explicit enable or disable.

### Fault Mapping

In implementing the prognostics algorithms, in some scenarios, the system may feed useful raw leading indicator data and algorithm outputs into a fault mapping matrix that uses known engineering data to determine the target system's current condition. Each target system subsystem and component is assigned useful fault modes that each are characterized by parameters which have known nominal values and permitted tolerances. The matrix correlates parameter values to an “OK” status and also out-of-tolerance statuses of varying severities when the parameters drift outside of acceptable ranges. These severities are mapped to prognostic timeframes—i.e., the time until a predicted failure—and a diagnostic trigger level where the parameter value indicates a current failure.

FIG. 2 illustrates a diagram of examples of faults as result of prognostics. In some non-limiting examples, specific faults for the above example may include:
1. Compressor
   a. Refrigerant Problem
   b. Nearing the end of useful life
2. Evaporator Coil
   a. Dirty Coil
3. Air Return Filter
   a. Filter Dirty
   b. Nearing the end of useful life
4. Condenser
   a. Coil or Filter Dirty
   b. Fan Degraded
5. Indoor Blower Unit
   a. Belt Slipping
   b. Fan Damage
   c. Motor Malfunction
6. Ducting
   a. Smoke Detected

All components also include a “stale data” fault that is triggered when data is not received for some prescribed period of time. This fault indicates that the displayed output is out-of-date and is only a representation of the system status as of the last time data was received.

In a non-limiting example, the prognostics engine can determine the “remaining useful life,” or RUL, of a component based on either historical data or runtime. In the first case, the function is similar to a prognostic alert where operating conditions, such as pressures, are compared to engineering data for the component to determine the current lifecycle state of the component. For example, if differential pressure data is available for a filter, that pressure reading can be correlated to the estimated number of days remaining on a filter before it requires changing. When that level of data is not available, the second case compares the operating time of a component to mean time between failure (MTBF) data from the component's manufacturer. This method is useful for components such as fan motors where no direct, measurable data is available, but the operating mode is available to log component runtime. This latter method is useful for switched electronic or frequently replaced components but is dependent upon manual input from service personnel who perform the maintenance.

Results can be displayed on a web-based graphical user interface (GUI) to provide a hierarchal view of the system and prognostic or diagnostic alerts, distinguished by color, for each component. Depending upon the GUI configuration, the display may also include a site-wide geographical display of target systems and their statuses, a graphical representation of individual target systems, and raw data charts to aid in maintenance actions. RUL is presented on a separate tabbed window. A separate “Event History” tabbed window allows the user to query historical event logs.

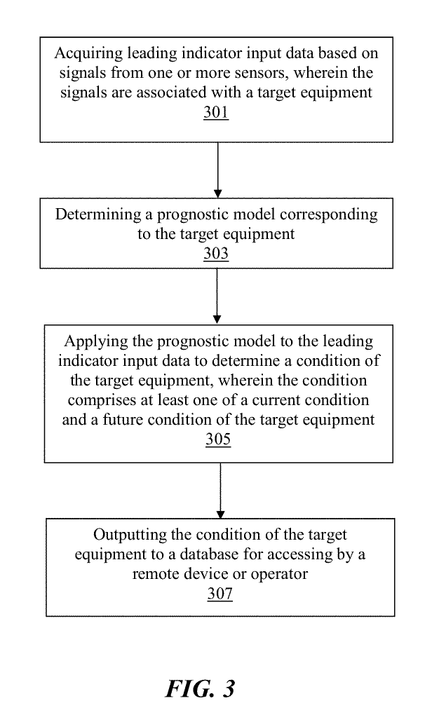

FIG. 3 illustrates an example of a method for monitoring a target equipment in a building management. The method begins at 301 with acquiring leading indicator input data based on signals from one or more sensors. The signals from the sensors are associated with a target equipment. At 303, the method also includes determining a prognostics model corresponding to the target equipment. At 305, the method includes applying the prognostics model to the leading indicator input data to determine a condition of the target equipment; the condition includes a current condition and/or a future condition of the target equipment. The method continues at 307 with outputting the condition of the target equipment to a database for accessing by a remote device or operator.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

Other objects, features, and advantages of the present invention will become apparent from the following detailed description. It should be understood, however, that the detailed description and the examples, while indicating specific embodiments of the invention, are given by way of illustration only. Additionally, it is contemplated that changes and modifications within the spirit and scope of the invention will become apparent to those skilled in the art from this detailed description.

We claim:

1. A prognostics system for monitoring a target equipment in a building management system comprising:
one or more sensors each configured to monitor a signal associated with the target equipment;
a processing device;
a data store containing prognostics models associated with one or more pieces of equipment in the building management system; and
non-transitory computer readable medium containing programming instructions configured to cause the processing device to:
acquire leading indicator input data representing the monitored signals associated with the target equipment,
determine a prognostics model corresponding to the target equipment,
apply the prognostics model to the leading indicator input data to determine a condition of the target equipment, wherein the condition comprises at least one of a current condition and a future condition of the target equipment, and
output the condition of the target equipment to a database for accessing by a remote device or operator.

2. The prognostics system of claim 1 further comprising programming instructions configured to generate, based on the current condition, an alert associated with an individual component or subsystem of the target equipment, wherein the alert comprises at least one of:
a failure alert of the target equipment indicating an existing fault that requires a corrective action; and
a prognostic alert predicting a future occurrence of a fault within a predetermined timeframe.

3. The prognostics system of claim 2, wherein the prognostic alert comprises a confidence level indicating a probability of occurrence of the fault within the predetermined timeframe based on the quality of the leading indicator input data.

4. The prognostics system of claim 1, further comprising:
programming instructions configured to provide a recommendation of corrective action based on the generated alert associated with the individual component or subsystem of the target equipment.

5. The prognostics system of claim 1, wherein the prognostics model comprises:
a hierarchical description associated with a piece of equipment in the building management system;
leading indicator input data associated with the piece of equipment in the building management system;
mathematical functions which are applied to the leading input data; and
a fault symptom mapping matrix relating the leading indicator input data to possible faults in the piece of equipment,
wherein the programming instructions for determining the current condition or predicting the future condition of the target equipment are configured to apply the fault symptom matrix to the leading indicator input data representing the monitored signals associated with the target equipment and the outputs of the mathematical calculations applied to these data to determine possible faults in the target equipment.

6. The prognostics system of claim 5, wherein the prognostics model comprising internally-generated data which further comprises times, locations, or system descriptions.

7. The prognostics system of claim 1, wherein the programming instructions for determining the condition of the target equipment are configured to:
compare actual observed operational results based on the acquired leading indicator data and simulated operational results.

8. The prognostics system of claim 1, wherein the programming instructions for determining the condition of the target equipment are configured to:
detect a deviation of the actual observed operational results based on the acquired leading indicator data from a nominal statistical pattern.

9. The prognostics system of claim 1, wherein the target system is an HVAC equipment, and the leading indicator input data comprise one or more of the following: fluid temperatures, hardware temperatures, hardware status proofs, operational settings, and fluid pressures.

10. The prognostics system of claim 1, wherein the prognostics model further comprises one or more functions configured to:
determine a normal operational status (baseline data) of the building management system;
refine the baseline data over time;
calculate a rooftop unit (RTU) return-to-supply air differential temperature;
determine a historical rate of change for one or more system parameters of the building management system;
calculate a refrigerant temperature based on a measured pressure;
determine that a compressor is running based on measured pressures; or
determine a true enable status of an indoor blower fan based on system status when non-measurable, internal logic is used by the target system such as a fan “auto” setting.

11. The prognostics system of claim 10, wherein the current condition of the target equipment comprises a remaining useful life (RUL) for individual components or subsystems with expected lifespans shorter than that of the overall system.

12. The prognostics system of claim 10, wherein the programming instructions for determining the current condition of the target equipment comprise programming instructions configured to:
determine an estimated RUL based on comparing measured system data with engineering data; or
determine an estimated RUL based on comparing an accumulated operating time of the filter with a mean time between failure (MTBF) data.

13. The prognostics system of claim 11, wherein the target equipment comprises a filter, for which the RUL is an estimated time remaining before it is required to change the filter.

14. The prognostics system of claim 1, wherein the programming instructions for determining the condition of the target equipment are configured to assign a specific fault to the individual component or subsystem.

15. A method for monitoring a target equipment in a building management system comprising:
acquiring leading indicator input data based on signals from one or more sensors, wherein the signals are associated with a target equipment;
determining a prognostics model corresponding to the target equipment;
applying the prognostics model to the leading indicator input data to determine a condition of the target equipment, wherein the condition comprises at least one of a current condition and a future condition of the target equipment; and
outputting the condition of the target equipment to a database for accessing by a remote device or operator.

16. The method of claim 15, further comprising:
generating, based on the current condition, an alert associated with an individual component or subsystem of the target equipment, wherein the alert comprises at least one of:
a failure alert of the target equipment indicating an existing fault that requires a corrective action; and
a prognostic alert predicting a future occurrence of a fault within a predetermined timeframe.

17. The method of claim 16, wherein the prognostic alert comprises a confidence level indicating a probability of occurrence of the fault within the predetermined timeframe based on the quality of the leading indicator input data.

18. The method of claim 15, further comprising:
providing a recommendation of corrective action based on the generated alert associated with the individual component or subsystem of the target equipment.

19. The method of claim 15, wherein the prognostics model comprises:
a hierarchical description associated with a piece of equipment in the building management system;
leading indicator input data associated with the piece of equipment in the building management system;
mathematical functions which are applied to the leading input data; and
a fault symptom mapping matrix relating the leading indicator input data to possible faults in the piece of equipment,
wherein the programming instructions for determining the current condition or predicting the future condition of the target equipment are configured to apply the fault symptom matrix to the leading indicator input data representing the monitored signals associated with the target equipment and the outputs of the mathematical calculations applied to these data to determine possible faults in the target equipment.

20. The method of claim 19, wherein the prognostics model comprising internally-generated data which further comprises times, locations, or system descriptions.

21. The method of claim 15, further comprising:
comparing actual observed operational results based on the acquired leading indicator data and simulated operational results to determine the condition of the target equipment.

22. The method of claim 15, further comprising:
detecting a deviation of the actual observed operational results based on the acquired leading indicator data from a nominal statistical pattern to determine the condition of the target equipment.

23. The method of claim 15, wherein the target system is an HVAC equipment, and the leading indicator input data comprise one or more of the following: fluid temperatures, hardware temperatures, hardware status proofs, operational settings, and fluid pressures.

24. The method of claim 15, wherein the prognostics model further comprises one or more functions configured to:
determine a normal operational status (baseline data) of the building management system;
refine the baseline data over time;
calculate a rooftop unit (RTU) return-to-supply air differential temperature;
determine a historical rate of change for one or more system parameters of the building management system;
calculate a refrigerant temperature based on a measured pressure;
determine that a compressor is running based on measured pressures; or
determine a true enable status of an indoor blower fan based on system status when non-measurable, internal logic is used by the target system such as a fan “auto” setting.

25. The method of claim 24, wherein the current condition of the target equipment comprises a remaining useful life (RUL) for individual components or subsystems with expected lifespans shorter than that of the overall system.

26. The method of claim 24, wherein the step of determining the current condition of the target equipment further comprises:
determining an estimated RUL based on comparing measured system data with engineering data; or
determining an estimated RUL based on comparing an accumulated operating time of the filter with a mean time between failure (MTBF) data.

27. The method of claim 25, wherein the target equipment comprises a filter, for which the RUL is an estimated time remaining before it is required to change the filter.

28. The method of claim 15, wherein the step of determining the condition of the target equipment further comprises assigning a specific fault to an individual component or subsystem.
